(19) United States
(12) Patent Application Publication
(10) Pub. No.: US 2026/0312499 A1
(43) Pub. Date: Oct. 8, 2026

(54) DECOUPLED CONTROL OF A POWER CONVERTER

(71) Applicant: ELECTRIC HYDROGEN CO., Devens, MA (US)

(72) Inventors: Ivan Petric, Belgrade (RS); Milan Ilic, San Jose, CA (US); Mariano Filippa, San Jose, CA (US)

(21) Appl. No.: 19/480,574

(22) PCT Filed: Apr. 15, 2024
(86) PCT No.: PCT/US2024/024600

§ 371 Date: Oct. 31, 2025

Related U.S. Application Data
(60) Provisional application No. 63/463,114, filed on May 1, 2023.

(51) Int. Cl. H02M 3/158; H02M 1/00

(52) U.S. Cl. CPC H02M 3/1586; H02M 1/0025

(57) ABSTRACT

A power converter system includes a power converter including a plurality of switching cells arranged in a plurality of submodules. The system may also include a controller that may obtain a plurality of feedback signals indicative of a plurality of controlled parameters and may detect changes in respective ones of the plurality of controlled parameters during operation of the power converter. The controller may generate control signals for adjusting respective duty cycles of the plurality of switching cells based on the detected changes, to control the power converter for a plurality of control objectives. The duty cycles may be adjusted such that one or more relationships between the duty cycles are maintained to provide that controlling the power converter for one of the control objectives does not affect control of the power converter for another one of the control objectives.

This application claims the benefit of U.S. Provisional Patent Application No. 63/463,114, filed May 1, 2023, which is hereby incorporated by reference in its entirety.

### FIELD

The following disclosure relates to control of a power converter, such as a direct current (DC) to DC power converter.

### BACKGROUND

Electrolyzer systems use electrical energy to drive a chemical reaction. For example, water is split to form hydrogen and oxygen. The products may be used as energy sources for later use. In recent years, improvements in operational efficiency have made electrolyzer systems competitive market solutions for energy storage, generation, and/or transport. For example, the cost of generation may be below $10 per kilogram of hydrogen in some cases. Increases in efficiency and/or improvements in operation will continue to drive installation of electrolyzer systems. An important aspect in overall efficiency of an electrolyzer system is efficiency of power supply components, such as a power converter, used to power operation of the electrolyzer system. For example, inefficiencies, such as energy loss, in a power converter used to power an electrolyzer system may increase the cost of operation of the electrolyzer system and may make the electrolyzer system less attractive for use as an energy storage, generation, and/or transport system.

### SUMMARY

In one embodiment, a power converter system is provided. The power converter system includes a power converter including a plurality of switching cells arranged in a plurality of submodules. The power converter system further includes a controller configured to: obtain a plurality of feedback signals indicative a plurality of controlled parameters of the power converter; detect, based on the plurality of feedback signals, changes in respective ones of the plurality of controlled parameters during operation of the power converter; generate, based on the changes in respective ones of the plurality of controlled parameters, a plurality of control signals for adjusting respective duty cycles of the plurality of switching cells to control the power converter for a plurality of control objectives, wherein the controller is configured to adjust the duty cycles such that one or more relationships between the respective duty cycles are maintained to provide that controlling the power converter for one of the plurality of control objectives does not affect control of the power converter for another one of the plurality of control objectives; and provide the plurality of the control signals to the plurality of switching cells to control the duty cycles of the plurality of switching cells.

In another embodiment, a method for controlling an operation of a power converter is provided. The method includes obtaining, by a controller, a plurality of feedback signals indicative of a plurality of controlled parameters of the power converter, wherein the power converter includes a plurality of switching cells arranged in a plurality of submodules. The method further includes detecting, by the controller based on the plurality of feedback signals, changes in respective ones of the plurality of controlled parameters during operation of the power converter. The method further includes generating, by the controller based on the changes in respective ones of the plurality of controlled parameters, a plurality of control signals for adjusting respective duty cycles of the plurality of switching cells to control the power converter for a plurality of control objectives, wherein the duty cycles are adjusted such that one or more relationships between the respective duty cycles are maintained to provide that controlling the power converter for one of the plurality of control objectives does not affect control of the power converter for another one of the plurality of control objectives. The method further includes providing, by the controller, the plurality of the control signals to the plurality of switching cells to control the duty cycles of the plurality of switching cells.

In another embodiment, a controller for a power converter is provided. The controller includes a feedback signal engine configured to obtain a plurality of feedback signals indicative of a plurality of controlled parameters of the power converter, wherein the power converter includes a plurality of switching cells arranged in a plurality of submodules. The controller further includes a plurality of control loops configured to generate, based on detected changes in respective ones of the plurality of controlled parameters, a plurality of control signals for adjusting respective duty cycles of the plurality of switching cells to control the power converter for a plurality of control objectives, wherein the controller is configured to adjust the duty cycles such that one or more relationships between the respective duty cycles are maintained to provide that controlling the power converter for one of the plurality of control objectives does not affect control of the power converter for another one of the plurality of control objectives.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Example implementations are described herein with reference to the following drawings.

FIG. 1 is a block diagram of an example power converter with a decoupled control system, according to an embodiment.

FIG. 2 is a circuit diagram of an example power converter that may be used as the power converter of FIG. 1, according to an embodiment.

FIG. 3 is a schematic diagram of an example average circuit representing an input side of the power converter of FIG. 2, according to an embodiment.

FIG. 4 is a schematic diagram of an example average circuit representing an output side of the power converter of FIG. 2, according to an embodiment.

FIG. 5 illustrates dynamic equations that describe the system of FIG. 1, according to an embodiment.

FIG. 6 is a block diagram depicting an example implementation of the decoupled control system of FIG. 1, according to an embodiment.

FIG. 7 is a block diagram illustrating several control loop models that model the decoupled control system of FIG. 1, according to an embodiment.

FIG. 8 is a block diagram of an example method of decoupled control of a power converter, according to an embodiment.

### DETAILED DESCRIPTION

Disclosed is a power converter system that includes a power converter and a controller configured to control the power converter for a plurality of control objectives. The power converter and the controller may be used in a large-scale (and/or other scale) electrolysis system, for example. In other examples, the power converters and control systems described herein may be used to convert power in various applications other than an electrolyzer application. For example, the power converters and control systems described may be applied to electrochemical processes other than electrolysis, for example electrochemical reduction of oxide ores, chloralkaline processes and the like, so long as they are powered by resources utilizing a power converter. In some examples, the power converters and control systems described herein may be used in electric vehicle (EV) charging systems, battery storage systems, and the like. In other examples, the power converters and control systems described herein may be applied to other energy storage, generation, and/or transport systems.

The power converter may be configured to convert input power supplied by a power source, such as a renewable energy power source or power grid, to an output power suitable for powering a load, such as an electrolyzer plant. The electrolyzer plant may include one or more electrochemical stacks, wherein each stack may contain 50-1000 electrochemical cells, 50-100 electrochemical cells, 500-700 electrochemical cells, or more than 1000 electrochemical cells. Any number of electrochemical cells may make up a stack. The electrochemical cells within the electrochemical stack may be configured to operate with 200 mV or less of pure resistive loss when operating at a high current density (e.g., at least 3 Amps/cm², at least 4 Amps/cm², at least 5 Amps/cm², at least 6 Amps/cm², at least 7 Amps/cm², at least 8 Amps/cm², at least 9 Amps/cm², at least 10 Amps/cm², at least 11 Amps/cm², at least 12 Amps/cm², at least 13 Amps/cm², at least 14 Amps/cm², at least 15 Amps/cm², at least 16 Amps/cm², at least 17 Amps/cm², at least 18 Amps/cm², at least 19 Amps/cm², at least 20 Amps/cm², at least 25 Amps/cm², at least 30 Amps/cm², in a range of 1-30 Amps/cm², in a range of 3-20 Amps/cm², in a range of 3-15 Amps/cm², in a range of 3-10 Amps/cm², or in a range of 10-20 Amps/cm²). In additional examples, the amount of water (e.g., deionized (DI) water) transferred to or circulated through each cell of the stack may be in a range of 0.25-1 mL/Amp/cell/min, in a range of 0.25-5 mL/Amp/cell/min, or in a range of 0.5-1 mL/Amp/cell/min.

The power converter may include a plurality of submodules that may, in turn, include a plurality of switching cells connected in parallel and/or in series to increase a voltage and/or current that may be converted and/or supplied by the power converter. During operation of the power converter, the controller may obtain a plurality of feedback signals indicative of a plurality of controlled parameters of the power converter. The plurality of controlled parameters may include i) a regulated output of the power converter, and one or both of i) one or more circulating currents in the plurality of submodules of the power converter and iii) respective input voltages (or input currents) provided to respective ones of the plurality of submodules of the power converter. In an example, the regulated output of the power converter may be a regulated output current of the power converter. Although the power converters and control systems are described herein in the context of regulation of an output current of the power converter, the regulated output of the power converter may additionally or alternatively include other forms of output of the power converter. For example, the regulated output of the power converter may include a suitable combination of one or more of a regulated output current of the power converter, a regulated output voltage of the power converter, and/or a regulated output power of the power converter. The controller may detect changes in respective ones of the plurality of controlled parameters during operation of the power converter based on the feedback signals obtained from the power converter. For example, the controller may detect an increase in circulating currents in the submodules of the power converter, a disbalance in input voltages provided to the respective submodules of the power converter, and/or a deviation of a regulated output current from a desired reference value.

The controller may generate a plurality of control signals for adjusting respective duty cycles of the plurality of switching cells to control the power converter for the plurality of control objectives. The plurality of control objectives may include i) regulation of the output of the power converter and one or both of ii) elimination of the one or more circulating currents in the power converter and iii) elimination of a disbalance between the respective input voltages provided to respective ones of the plurality of submodules of the power converter, for example. In examples, if circulating currents are not controlled to be at least substantially equal to zero, increase the total current root mean square (RMS) value of the currents flowing through the power converter. The increased currents may potentially saturate components of the power converter, which may increase the overall losses and ripples on the circulating currents in the power converter. With respect to the disbalance between the respective input voltages provided to respective ones of the plurality of submodules of the power converter, if the input voltages are not balanced, a voltage at one of the submodules may exceed the voltage rating of power converter components in that submodule, which may cause failure of the components of that submodule. Further, similar to the effect of the circulating currents between the two submodules, the input voltage imbalance may also cause an increase in the ripple on the output current, which may increase losses in the power converter and, in some cases, may cause damage in the power converter and/or the load coupled to the output of the power converter.

In an embodiment, the controller may be configured to adjust the duty cycles of the respective switching cells of the power converter to control the power converter in a decoupled manner such that control of the power converter for any one of the plurality of control objectives does not affect operation of the power converter with respect to any other one of the control objective. For example, the controller is configured to adjust the respective duty cycles of the respective switching cells of the power converter such that one or more relationships between the respective duty cycles are maintained to provide that controlling the power converter for one of the plurality of control objectives does not affect control of the power converter for another one of the plurality of control objectives. As a more specific example, to decouple control of the power converter for elimination of circulating currents in the submodules of the power converter from control of the power converter for balancing the input voltages provided to the respective modules of the power converter and regulation of the output current of the power converter, the controller may adjust the duty cycles of the switching cells of the power converter such that a difference between duty cycles of switching cells in a particular submodule of the power converter is changed without changing a sum of the duty cycles of the switching cells in the particular submodule of the power converter. As another example, to decouple control of the power converter for balancing the input voltages provided to the respective modules of the power converter from control of the power converter for elimination of circulating currents in the submodules of the power converter, the controller may adjust the duty cycles of the switching cells of the power converter such that a difference between sums of duty cycles of the switching cells in respective submodules of the power converter is changed without changing differences between duty cycles of the switching cells in any particular submodule of the power converter. As still another example, to decouple control of the power converter for regulation of the output current of the power converter from control of the power converter for elimination of circulating currents in the submodules of the power converter, the controller may adjust the duty cycles of the switching cells of the power converter such that a mean value of the duty cycles of the switching cells of power converter is changed without changing respective differences of the duty cycles of the switching cells in the submodules of the power converter. Such decoupled control of the power converter may guarantee optimal operation of the power converter, in terms of current ripples, semiconductor voltage stresses, and magnetic core utilization, consequently increasing overall system efficiency and cost, in at least some embodiments.

In at least some examples, because the control systems described herein perform control in a decoupled manner, each regulation task may be performed in an optimal way, without mutual interference. For example, the control systems described herein enable robust operation of the power converter by preventing circulating currents even during fast transients and by balancing the split dc bus voltages, without impacting the output current regulation, in at least some embodiments. In such ways, the control systems described herein decrease losses and cost of running the power converter system (and/or its load) and improve reliability of the power converter system (and/or its load), in at least some embodiments.

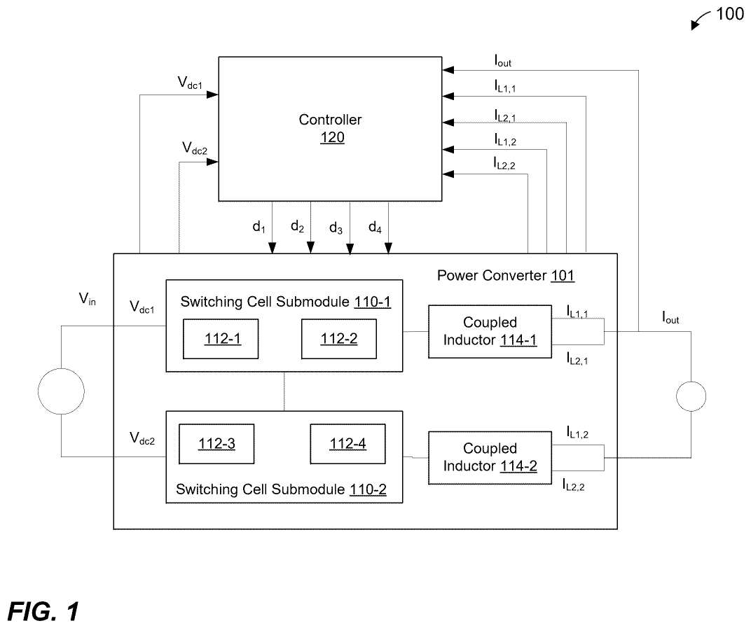

FIG. 1 is a block diagram of an example power converter system 100 with a decoupled control system, according to an embodiment. The power converter system 100 includes a power converter 101 having a plurality of switching cell modules 110, including at least a first switching cell submodule 110-1 and a second switching submodule 110-2. Each of the first switching cell module 110-1 and the second switching cell module 110-2 includes one or more switching cells 112. For example, each of the first switching cell module 110-1 and the second switching modules 110-2 includes two switching cells 112, in the illustrated embodiment. A first coupled inductor 114-1 may be provided at the output of the first switching module 110-1 to combine outputs of the switching cells 112 of the first switching module 110-1. Similarly, a second coupled inductor 114-2 may be provided at the output of the second switching module 110-2 to combine outputs of the multiple switching cells of the second switching module 110-2. The power converter 101 may thus be configured as an interleaved three-level, direct current (DC) to DC power converter. In other examples, other suitable configurations of the power converter 101 having a plurality of switching cell modules 110 may be utilized.

Although the power converter 101 is illustrated in FIG. 1 as including two switching cell submodules 110, the power converter 101 may include other suitable numbers (e.g., 3, 4, 5, et.) of switching cell modules, in other embodiments. Further, although each of the switching cell submodules 110 is illustrated in FIG. 1 as including two switching cells 112, each of the switching cell submodules includes a suitable number (e.g., 3, 4, 5, etc.) of switching cells other than two switching cells 112, in some embodiments. In some embodiments, the power converter 101 includes only a single switching module 110, where the single switching module 110 includes multiple switching modules stacked in parallel. In some embodiments, the power converter 101 includes multiple switching modules 110, where each of the multiple switching modules 110 includes a plurality of switching cells 112. A greater number of switching submodules 110 and/or a greater number of switching cells 112 in each of the switching submodules 112 included in each of the switching submodules 110 may increase a voltage and/or current output that may be provided by the power converter 101.

The power converter 101 may be configured as a direct current DC-DC power converter. In another example, the power converter 101 may be configured as a DC to alternating current (DC-AC) power converter. In certain examples, the power converter 101 may have various power conversion configurations, such as boost, buck-boost, Cuk, Sepic, etc. configurations. In some examples, the flow of power in the power converter 101 may be reversed. For example, although the power converter 101 is illustrated in FIG. 1 as having the switching cell submodules 110 coupled to a load via the coupled inductors 114 on one side and coupled to a source Vᵢₙ on the other side, the flow of power may be reversed with the switching cell submodules 110 coupled to a source via the coupled inductors 114 on one side and coupled to a load on the other side, in other embodiments.

The power converter system 100 also includes a controller 120. The controller 120 may be a part of or implemented by a digital signal processor, for example. The controller 120 may be configured to obtain a plurality of feedback signals indicative of a plurality of controlled parameters of the power converter 110. For example, the controller 120 may be configured to obtain a feedback signal indicative of the regulated output current Iₒᵤₜ, in an embodiment. The controller 120 may also be configured to obtain one or both of i) feedback signals indicative of circulating currents in respective ones of the plurality of submodules 110 and ii) feedback signals indicative of input voltages (e.g., provided to the respective ones of the plurality of submodules 110. In the illustrated embodiment with two submodules 110 and the coupled inductors 114 provided to combine outputs of two switching cells 112 in each of the submodules 110, the controller 120 may be configured to receive feedback signals indicative of circulating currents I_{L1,1}, I_{L1,2} in the first coupled indictor 114-1, circulating currents I_{L2,1}, I_{L2,2} in the second coupled inductor 114-2, a first input voltage V_{dc1} supplied to the first submodule 110-1 and a second input voltage V_{dc2} supplied to the second submodule 110-1.

It is noted that although the power converter 101 is described herein in the context of regulation of the output current Iₒᵤₜ, the regulated output of the power converter 101 may additionally or alternatively include other forms of output. For example, the regulated output of the power converter 101 may include any suitable combination of one or more or a regulated output current, a regulated output voltage, and/or a regulated output power, in certain examples.

With continued reference to FIG. 1, the controller 120 may be configured to detect changes in respective ones of the plurality of controlled parameters during operation of the power converter. For example, the controller 120 may be configured to detect increases in circulating currents in the submodules 110 of the power converter 101, increases in input voltage disbalance between the input voltages provided to the submodules 110 of the power converter 101, and deviations of the regulated current Iₒᵤₜ from a desired reference current. Based on the detected changes in respective ones of the plurality of controlled parameters, the controller 120 may generate a plurality of control signals for adjusting respective switching duty cycles of the plurality of switching cells 112 to achieve a plurality of control objectives. The plurality of control objectives of the controller 120 may include i) regulation of the output current Iₒᵤₜ of the power converter 101, ii) cancellation of the circulating currents I_{L1,1}, I_{L1,2} I_{L2,1}, I_{L2,2} in the power converter 101 and iii) elimination of a disbalance between the input voltages V_{dc1}, V_{dc2} supplied to respective ones of the plurality of submodules 110 of the power converter 101. The controller 120 may be configured to generate control signals to adjust the switching duty cycles d₁, d₂, d₃, d₄ of the switching cells 112-1, 112-2, 112-3, 112-4 to achieve the plurality of control objectives, in the illustrated embodiment.

In an embodiment, as described in more detail below, the controller 120 is configured to adjust the switching duty cycles of the plurality of switching cells 112 such that one or more relationships between the respective duty cycles of the switching cells 112 are maintained to provide that controlling for one of the plurality of control objectives does not affect control for another one of the plurality of control objectives. The controller 120 may be configured to control the circulating currents in a submodule 110 by changing a difference between the switching duty cycles of the two switching cells 112 of the submodule 110. Further, the controller 120 may be configured to control the balance between the input voltages V_{dc1}, V_{dc2} supplied to respective ones of the submodules 110 by adjusting a difference between the sums of the switching duty cycles of the switching cells 112 in the respective submodules 110. In an embodiment, in order to control one of i) the circulating currents in the submodules 110 and ii) the balance between the input voltages supplied to the submodules 110, the controller 120 is configured to adjust the switching duty cycles of the switching cells 112 such that certain relationships between the respective duty cycles remain unchanged so as not to affect the other one of i) the circulating currents in the submodules 110 and ii) the balance between the input voltages supplied to the submodules 110.

For example, to control the power converter 101 for the control objective of elimination of the circulating currents I_{L1,1}, I_{L1,2} in the first submodule 110-1, the controller 120 may change a difference between the switching duty cycle d₁ of the switching cell 112-1 and the switching duty cycle d₂ of the switching cell 112-2. In an embodiment, the controller 120 may change the difference between d₁ and d₂ in a manner that provides that the sum between d₁ and d₂ remains unchanged so as to not affect the balance between the input voltages V_{dc1}, V_{dc2} provided to the first submodule 110-1 and the second submodule 110-2. For example, the controller 120 may calculate a desired value (Δd₁₂) of change to the difference between d₁ and d₂ and cause the desired change by adding one half of the desired value (½ Δd₁₂) to d₁ and subtracting one half of the desired value (½ Δd₁₂) from d₂, or vice-versa, depending on the direction of the desired change. Similarly, to control the power converter 101 for the control objective of elimination of the circulating currents I_{L2,1}, I_{L2,2} in the second submodule 110-1, the controller 120 may change a difference between the switching duty cycle d₃ of the switching cell 112-3 and the switching duty cycle d₄ of the switching cell 112-4. In an embodiment, the controller 120 may change the difference between d₃ and d₄ in a manner that provides that the sum between d₃ and d₄ remains unchanged so as to not affect the balance between the input voltages V_{dc1}, V_{dc2} provided to the first submodule 110-1 and the second submodule 110-2. For example, the controller 120 may calculate a desired value (Δd₃₄) of change to the difference between d₃ and d₄ and cause the desired change by adding one half of the desired value (½ Δd₃₄) to d₃ and subtracting one half of the desired value (½ Δd₃₄) from d₄, or vice-versa, depending on the direction of the desired change.

As another example, to control the power converter 101 for the control objective of elimination of a disbalance between the input voltages V_{dc1}, V_{dc2} provided to the first submodule 110-1 and the second submodule 110-2, the controller 120 may change a difference between the mean values of d₁, d₂ (i.e., ½(d₁+d₂)) and d₃, d₄ i.e., ½(d₃+d₄)). In an embodiment, the controller 120 may change the difference between the mean values of d₁, d₂ and d₃, d₄ in a manner that provides that the differences between i) d₁ and d₂ and ii) d₃ and d₄ remain unchanged so as to not affect the circulating currents I_{L1,1}, I_{L1,2} I_{L2,1}, I_{L2,2} in the first submodule 110-1 and the second submodule 110-2. For example, the controller 120 may calculate a desired value (ΔD) of change to the difference between the mean values of d₁, d₂ and d₃, d₄, and may cause the change by adding one half of the desired value (½ ΔD) to each of d₁ and d₂ and subtracting one half of the desired value (½ ΔD) to each of d₃ and d₄, for example.

Referring still to FIG. 1, in at least some examples, the change (ΔD) in the difference between the mean values of d₁, d₂ and d₃, d₄ may have an effect on the regulated output current Iₒᵤₜ. The controller 120 may thus be configured to implement a feedforward correction to compensate for the effect of the change in ΔD. In some embodiments, the controller 120 may implement a voltage balancer and an output current controller with a dynamic bandwidth separation such that the voltage balancer is significantly slower relative to the output current controller. In these ways, the output current controller may at least substantially reject the disturbance from the change in ΔD caused by the voltage balancer.

In some embodiments, due to complicated current ripple shape in the power converter, caused, for example, by the coupled inductors 114 of the power converter, standardly used approach of sampling once or twice per switching cycle may result in high acquisition errors, which may consequently lead to regulation errors (e.g., circulating currents may appear and/or the regulated output current may not correspond to the desired reference value). The controller 120 may thus include an oversampled averaging engine configured to oversample and average the feedback signals indicative of circulating currents in the power converter to provide true DC values of the measured currents. These and other techniques described herein provide that optimal operation of the power converter, in terms of current ripples, semiconductor voltage stresses, and magnetic core utilization, are achieved for the power converter 101, consequently increasing overall system efficiency and cost, in at least some embodiments.

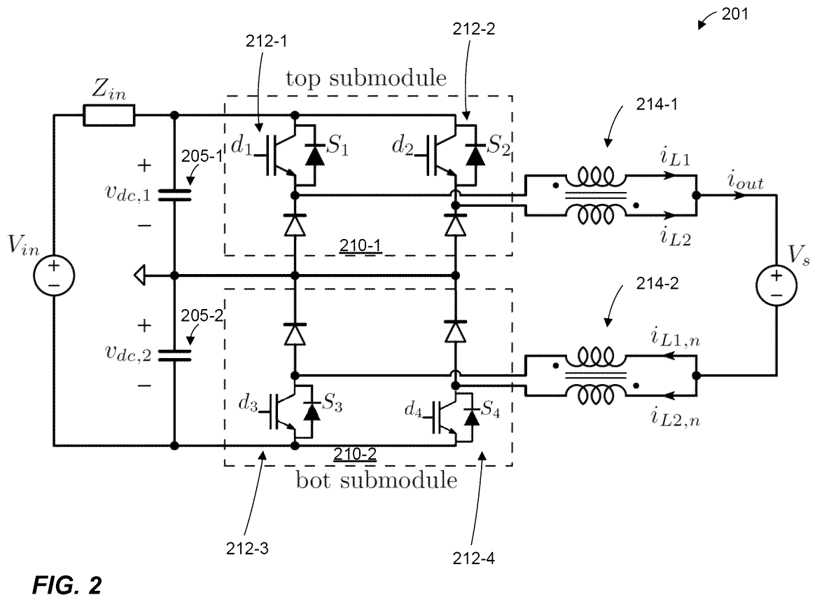

FIG. 2 is a circuit diagram of an example power converter 201 that may be used as the power converter of FIG. 1, according to an embodiment. The power converter 201 corresponds to the power converter 101 of FIG. 1, in an embodiment. The power converter 201 is configured as a three-level two-phase buck converter with coupled inductors, in the illustrated embodiment. The power converter 201 includes a three-level interleaved structure including four switching cells 212-1, 212-2, 212-3, 212-4 arranged in a first submodule 210-1 (also referred to herein as a “top submodule”) and a second submodule 210-2 (also referred to herein as a “bottom submodule”). The switching cells 212-1, 212-2 are stacked in parallel with each other in the top submodule 210-1. The switching cells 212-3, 212-4 are stacked in parallel with each other in the bottom submodule 210-2. Further, the switching cell 212-1 in the top submodule 210-1 is stacked in series with the switching cell 212-3 in the bottom submodule 210-2. Similarly, the switching cell 212-3 in the top submodule 210-1 is stacked in series with the switching cell 212-4 in the bottom submodule 210-2. An input voltage V_{dc1} is provided to the top submodule 210-1 across a first capacitor 205-1. An input voltage V_{dc2} is provided to the bottom submodule 210-2 across a second capacitor 205-2. A first coupled inductor 214-1 is connected to output terminals of the switching cells 212-1, 212-2 of the top submodule 210-1. A second coupled inductor 214-2 is connected to the output terminals of the switching cells 212-3, 212-4 of the bottom submodule 210-2.

Each of the switching cells 212 includes a respective transistor coupled in parallel with a respective diode, in the illustrated embodiment. In an embodiment, each of the transistors includes an insulated-gate bipolar transistor (IGBT). In other embodiments, the transistors may include suitable types of transistors other than IGBT. The diodes may be replaced with transistors in some embodiments. For example, the diodes may be replaced with IGBTs or other suitable types of transistors, in various embodiments.

Switching duty cycles d₁, d₂, d₃, d₄ of the switching cells 212-1, 212-2, 212-2, 212-4 are controlled by control signals provided to the switches S1, S2, S3, S4, in an embodiment. The switching cells 212 may be switched with appropriate time-shifts between them (termed N interleaving) that enables significant reduction of the currents' ripples and consequently smaller reactive filters. In certain examples, without any circuit imperfections and asymmetries, duty cycles d₁, d₂, d₃, d₄ of the switching cells 212 may be set equal, which theoretically provides zero circulating currents and balanced input voltages. However, in various embodiments, asymmetries, such as tolerances in turn on/off times of IGBTs, parasitic resistances, etc., exist in the power converter 201. The imbalances lead to circulating currents between the submodules 210 of the power converter 201, in an embodiment. Further, transient conditions may result in an imbalance between the input voltages to the submodules 210 of the power converter 201.

In an example, the circulating current circulating currents i_{L1}-i_{L2} and i_{L1n}-i_{L2n}, if not controlled to be at least substantially equal to zero, increase the total current root mean square (RMS) value of the currents flowing through switches S1, S2, S3, S4 and the inductors L1, L2. The increased currents may potentially saturate the coupled indictors 214-1 and 214-2, which may increase the overall losses and ripples on the circulating currents in the submodules 210. With respect to the input voltage disbalance between the submodules 210, if the input voltages are not balanced, a voltage at one of the submodules may exceed the voltage rating of the transistors and/or the diodes of that submodule, which may cause failure of transistors and/or the diodes of that submodule. Further, similar to the effect of the circulating currents between the two submodules, the input voltage imbalance may also cause an increase in the ripple on the output current, which may increase losses in the power converter and, in some cases, may cause damage in the power converter and/or the load coupled to the output of the power converter.

The power converter 212 may be controlled by a controller such as the controller 120 of FIG. 1, in an embodiment. The controller 120 may be configured to provide control signals for adjusting the switching cycles d₁, d₂, d₃, d₄ to the switching cells 212 of the power converter 201. In various embodiment, depending on the particular configuration of the power converter 201, the control objectives of the controller 120 may be i) to achieve output current at least substantially equal to desired reference value, and one or both of ii) to keep circulating currents (i_{L1}-i_{L2} and i_{L1n}-i_{L2n}) at least substantially close to 0 and iii) to keep input capacitor voltages at least substantially balanced (V_{dc1}−V_{dc2=0}). However, controlling the power converter 212 to achieve each individual control objective without regard to effects that control for the individual control objective has on one or more other control objectives may negatively affect operation of the power converter 212, in at least some situations. For example, controlling the power converter 201 for the circulating current control objective without regard to the voltage balancing objective may introduce or increase the voltage imbalance between the submodules 210, in at least some situations. Similarly, controlling the power converter 201 for the voltage balancing objective without regard to the circulating current objective may introduce or increase the circulating currents in the submodules 210, in at least some situations.

In an embodiment, the controller 120 is configured to control the power converter 120 for the various control objects in a manner that decouples control for any one of the control objectives from control for any other one of the control objectives. In an embodiment, to achieve the decoupled control of the power converter 201, the controller 120 is configured to control the power converter 201 by adjusting combinations of the values of d₁, d₂, d₃, d₄, rather than individual values of d₁, d₂, d₃, d₄, such that certain sums and/or differences between the adjusted values of d₁, d₂, d₃, d₄ remain unchanged. For example, the controller 120 is configured to modify the values of d₁, d₂, d₃, d₄ such that d₁, d₂, d₃, d₄ are controlled as (d₁+d₂)/2, (d₃+d₄)/2, (d₁−d₂)/2, (d₃−d₄)/2, as these sums and differences (and not individual values) directly affect each of the control objectives without affecting other ones of the control objectives, in an embodiment.

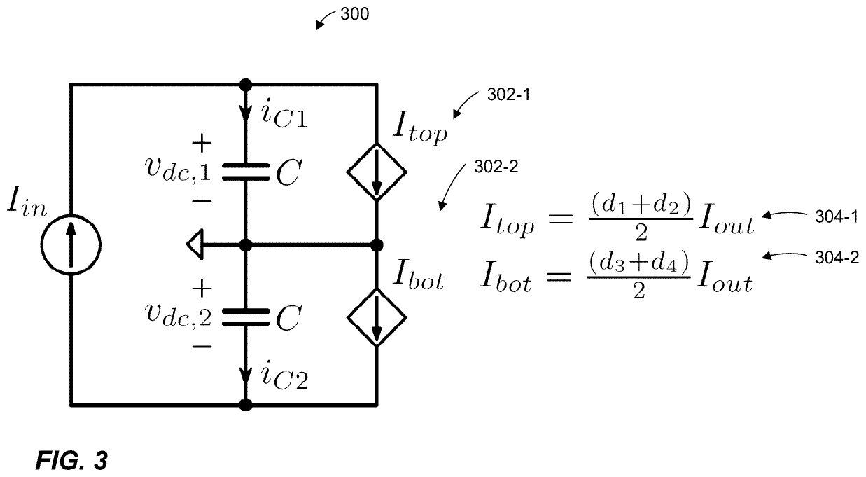

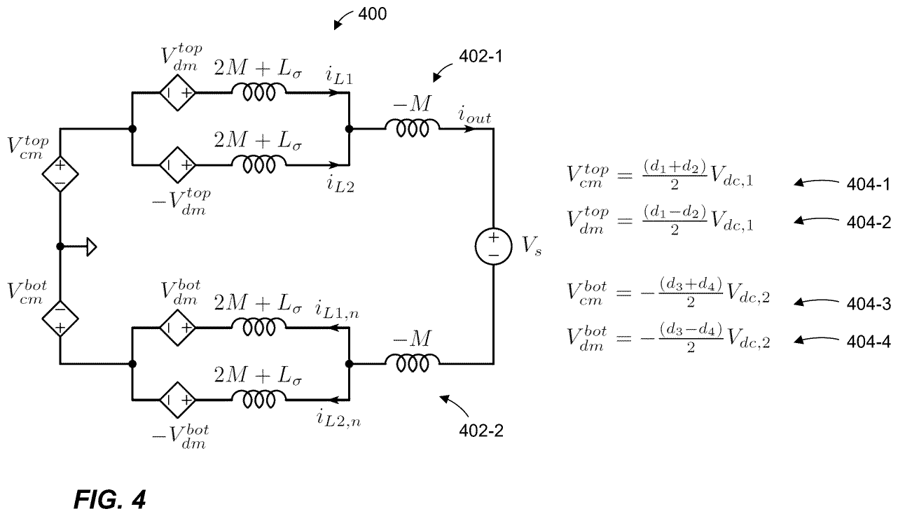

Referring to FIGS. 3 and 4, the input and the output sides of the power converter 201 of FIG. 2 may be represented, respectively, by average circuits 300, 400, according to an embodiment. With reference to FIGS. 2 and 3, the voltage V_{dc1} provided the top module 210-1 in FIG. 2 is the voltage across the input capacitance of the top module 210-1 and its load may be represented as a current source (Iₜₒₚ) depicted in FIG. 3, and the voltage V_{dc2} provided to the bottom module 210-2 in FIG. 2 is the voltage across the input capacitance of the bottom module 210-2 and its load may be represented as a current source 302-2 (I_{bot}) in FIG. 3. As illustrated in FIG. 3, the currents Iₜₒₚ and I_{bot} may be expressed, in terms of d₁, d₂, d₃, d₄ by, respectively, equations 304-1, 304-2. Referring now to FIGS. 2 and 4, the circuit for calculating the circulating currents i_{L1}-i_{L2} and i_{L1n}-i_{L2n} in the top module 212-1 and the bottom module 212-2 in FIG. 2 may be modeled as a top common mode voltage source

$${V}_{c m}^{top}$$

applied to a top output average circuit 402-1 including i) a positive differential mode voltage source

$${V}_{d m}^{top}$$

coupled in series with an inductance 2M+L_{σ}, i) a negative differential mode voltage source

$$- {V}_{d m}^{top}$$

coupled in series with an inductance 2M+L_{σ}, and iii) a mutual inductance −M, and a common mode voltage source

$${V}_{c m}^{bot}$$

applied to a bottom output average circuit 402-2 including i) a positive differential mode voltage source

$${V}_{d m}^{bot}$$

coupled in series with an inductance 2M+L_{σ}, i) a negative differential mode voltage source

$$- {V}_{d m}^{bot}$$

coupled in series with an inductance 2M+L_{σ}, and iii) a mutual inductance −M. As illustrated in FIG. 4, the voltages

$${V}_{c m}^{top} , {V}_{d m}^{top} , {V}_{c m}^{top} , {V}_{d m}^{top}$$

may be expressed, in terms of duty cycles d₁, d₂, d₃, d₄ by, respectively, equations 404-1, 404-2, 404-3, and 404-4.

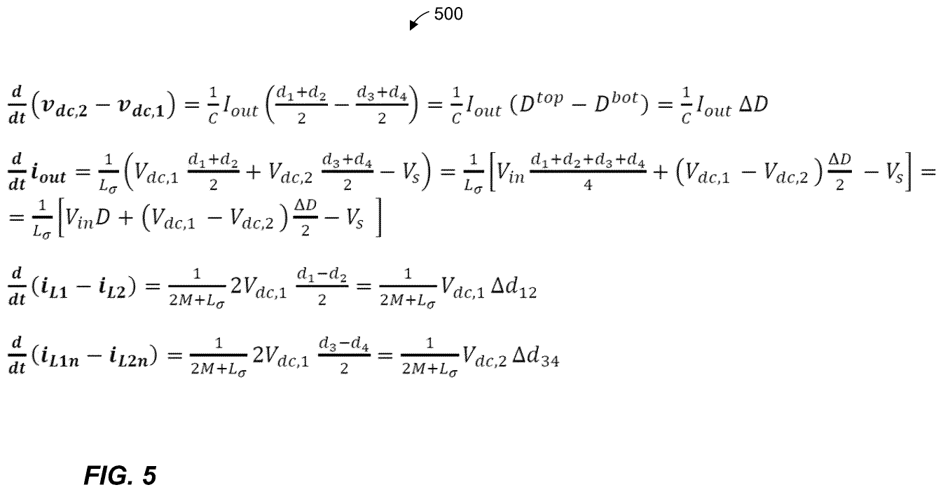

FIG. 5 illustrates a set of dynamic equations 500 that may be derived based on the input side average circuit 300 of FIG. 3 and the output side average circuit 400 of FIG. 4 with the controller 120 operating to regulate the circulating currents in the submodules 210-1 and 210-2 to be equal to zero. As can be seen from the equations 500, circulating currents in a particular submodule 210 are only impacted by differences in duty cycles (Δd₁₂ and Δd₃₄) of the particular submodule 210. By changing these differences only, without impacting their sums, the controller 120 may control the circulating currents without impacting the rest of the system. As can also be seen in the equations 500, due to coupled inductors, inductances that affect the circulating current response are equal to 2M+L_{σ}. Input capacitor voltage balance is impacted by the difference of sums of the duty cycles of the submodules 210

$$( \frac{{d}_{1} + {d}_{2}}{2} - \frac{{d}_{3} + {d}_{4}}{2} = Dtop - Dbot = Δ D ) .$$

As can be seen from equations 500, as long as the difference ΔD is not changed, input voltages do not change as well. Output current controller and circulating current controllers must not affect this difference.

With continued reference to the equations 500, it can be seen that the output current is impacted by mean values of duty cycles of the switching cells in both submodules. In an embodiment, so as to not perturb the input voltages and circulating currents, the controller 120 is configured to control the output current by setting all individual duty cycles to be the same (equal to D). This corresponds to what the controller 120 would do if everything were symmetric and balanced. In an example, inductance that affects the output current response due to the coupled inductors of the power converter is equal to L_{σ}. From the equations 500, it can be seen that, when voltage balancer acts by changing ΔD, this affects the output current as well. This represents a coupling between the voltage balancer and the output current controller. From perspective of the output current controller, voltage balancer is a disturbance and therefore its action should be compensated. This compensation is achieved with a feedforward action and by making dynamic bandwidth separation between the two controllers, such that the voltage balancer is much slower. In this way, output current control loop can successfully reject disturbance coming from the balancer.

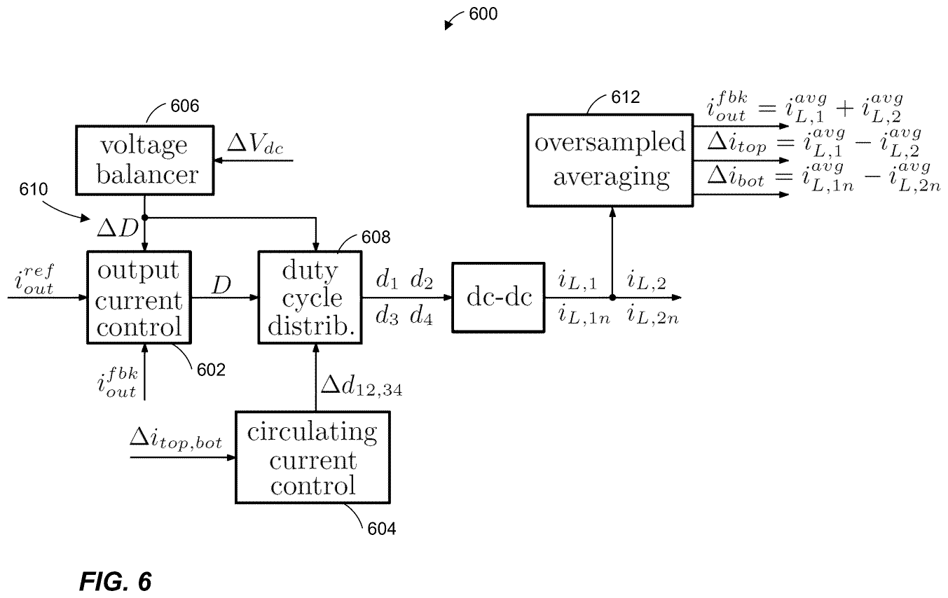

FIG. 6 is a block diagram depicting an example implementation of a controller 600, according to an embodiment. In an embodiment, the controller 600 corresponds to the controller 120 of FIG. 1. The controller 600 may be a part of or implemented by a digital signal processor, for example. In the example configuration of FIG. 6, the controller 600 includes an output current controller 602, a circulating current controller 604, and a voltage balancer 606, and a duty cycle determination engine 608. The output current controller 602 and the circulating current controller 604 are designed to have the same dynamic bandwidth, in an embodiment. The same dynamic bandwidth of the current controller 602 the circulating current controller 604 guarantees optimal response and zero circulating currents even in response to fast transients, in at least some embodiments. Such design can be achieved because of the decoupling between the output current controller 602 and the circulating current controller 604 as described herein. The voltage balancer 606 may be designed with a significantly lower bandwidth relative to the bandwidth of the output current controller 602. In an embodiment, the controller 600 may also include a feedforward correction loop 610 configured to compensate for disturbances in the output current control caused by the voltage balancer 606. Due to the significantly lower bandwidth of the voltage balancer 606 and the feedforward correction loop 610, control of the power converter for balancing the input voltage of the power converter may not disturb the output current regulation of the power converter. This low-bandwidth design can be tolerated because perturbations on the input voltage are slow. Slow effects on the output current regulation caused by the voltage balancer 606 may be compensated for in a feedforward loop, in an embodiment.

In some embodiments, due to complicated current ripple shape in the power converter, caused, for example, by the coupled inductors 214 of the power converter, standardly used approach of sampling once or twice per switching cycle may result in high acquisition errors, which may consequently lead to regulation errors (e.g., circulating currents may appear and/or the regulated output current may not correspond to the desired reference value). The controller 600 may thus also include an oversampled averaging engine 612 configured to oversample and average the feedback signals indicative of circulating currents in the power converter to provide true DC values of the measured currents. In an example, the oversampled averaging engine 612 is implemented using direct memory access (DMA) module of the digital signal processor. In this way, true average values of feedback signals are acquired, without impacting the algorithm execution time.

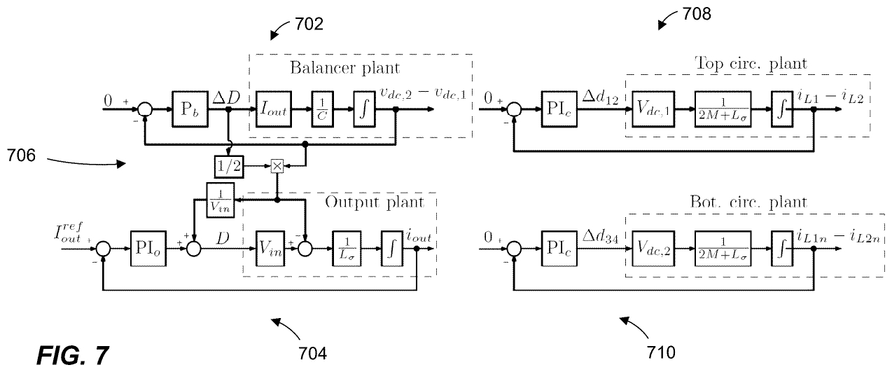

FIG. 7 is a block diagram depicting individual closed-loop control systems 700 of the controller 600 of FIG. 6, according to an embodiment. The individual closed loop control systems 700 include a balancer plant 702 coupled to an output plant 704 and decoupled via a feedforward loop 706. The individual closed loop control systems 700 also include a top circulating current plant 708 and a bottom circulating current plant 710. In an example, after all control loops are executed, individual duty cycles d₁, d₂, d₃, d₄ for the respective switching cells of the power converter are determined based on Equations 1-4:

$${d}_{1} = D + \frac{Δ D}{2} + \frac{Δ {d}_{12}}{2} \qquad Equation 1$$

$${d}_{2} = D + \frac{Δ D}{2} - \frac{Δ {d}_{12}}{2} \qquad Equation 2$$

$${d}_{3} = D - \frac{Δ D}{2} + \frac{Δ {d}_{34}}{2} \qquad Equation 3$$

$${d}_{4} = D - \frac{Δ D}{2} - \frac{Δ {d}_{34}}{2} \qquad Equation 4$$

Determining the individual duty cycles d₁, d₂, d₃, d₄ for the respective switching cells of the power converter according to Equations 1-4 provides that the duty cycles of d₁, d₂, d₃, d₄ are adjusted such that certain sums and/or differences between the adjusted values of d₁, d₂, d₃, d₄ remain unchanged. For example, Determining the individual duty cycles d₁, d₂, d₃, d₄ for the respective switching cells of the power converter according to Equations 1-4 provides that the values of d₁, d₂, d₃, d₄ are adjusted such that (d₁+d₂)/2, (d₃+d₄)/2, (d₁−d₂)/2, (d₃−d₄)/2 in combinations, rather than individually, as these combinations directly affect each of the control objectives without affecting other ones of the control objectives, in an embodiment. In other example, the individual duty cycles d₁, d₂, d₃, d₄ for the respective switching cells of the power converter are determined in other suitable manners that provide that the duty cycles of d₁, d₂, d₃, d₄ are adjusted such that certain sums and/or differences between the adjusted values of d₁, d₂, d₃, d₄ remain unchanged.

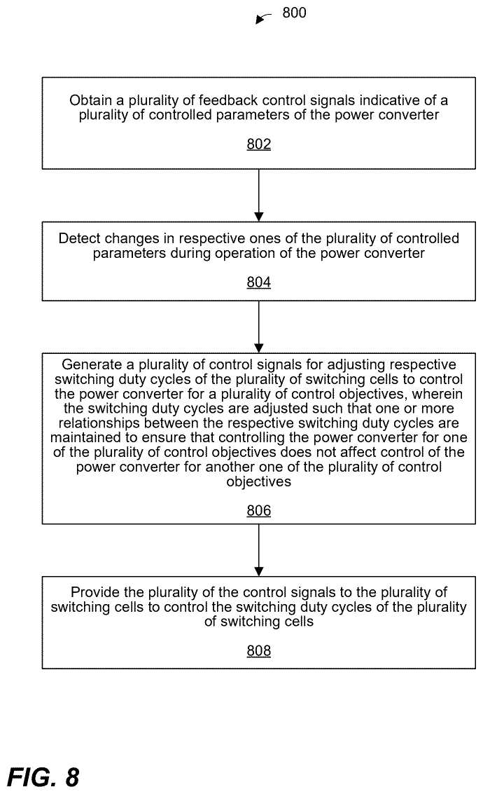

FIG. 8 is a block diagram of an example method 800 for controlling a power converter, according to an embodiment. In an embodiment, the method 800 is implemented by the controller 120 of FIG. 1 to control a power converter that includes a plurality of switching cells arranged in a plurality of submodules. The power converter controlled according to the method 800 corresponds to the power converter 101 of FIG. 1 or the power converter 201 of FIG. 2, in an embodiment. In another embodiment, the method 800 is implemented by a suitable controller different from the controller 120 of FIG. 1 and/or to control a suitable power converter different from the power converter 101 of FIG. 1 or the power converter 201 of FIG. 2.

At block 802, the controller may obtain a plurality of feedback signals indicative of a plurality of controlled parameters of the power converter. The plurality of controlled parameters may include i) a regulated output current of the power converter, and one or both of i) one or more circulating currents in the plurality of submodules of the power converter and iii) respective input voltages provided to respective ones of the plurality of submodules of the power converter. In other examples, the plurality of controlled parameters additionally or alternatively includes other suitable parameters of the power converter.

At block 804, the controller may detect changes in respective ones of the plurality of controlled parameters during operation of the power converter. Detection of the changes may be performed based on the feedback signals obtained at block 802. For example, the controller may detect an increase in one or more circulating currents in the submodules of the power converter, a disbalance in input voltages provided to the respective submodules of the power converter, and/or a deviation of a regulated output current from a desired reference value.

At block 806, the controller may generate a plurality of control signals for adjusting respective switching duty cycles of the plurality of switching cells to control the power converter for a plurality of control objectives. The switching duty cycles are adjusted such that one or more relationships between the respective switching duty cycles are maintained to provide that controlling the power converter for one of the plurality of control objectives does not affect control of the power converter for another one of the plurality of control objectives. For example, to decouple control of the power converter for elimination of circulating currents in the submodules of the power converter from control of the power converter for balancing the input voltages provided to the respective modules of the power converter and regulation of the output current of the power converter, the controller may adjust the switching duty cycles of the switching cells of the power converter such that a difference between switching duty cycles of switching cells in a particular submodule of the power converter is changed without changing a sum of the switching duty cycles of the switching cells in the particular submodule of the power converter. As another example, to decouple control of the power converter for balancing the input voltages provided to the respective modules of the power converter from control of the power converter for elimination of circulating currents in the submodules of the power converter, the controller may adjust the switching duty cycles of the switching cells of the power converter such that a difference between sums of switching duty cycles of the switching cells in respective submodules of the power converter is changed without changing differences between switching duty cycles of the switching cells in any particular submodule of the power converter. As still another example, to decouple control of the power converter for regulation of the output current of the power converter from control of the power converter for elimination of circulating currents in the submodules of the power converter, the controller may adjust the switching duty cycles of the switching cells of the power converter such that a mean value of the switching duty cycles of the switching cells of power converter is changed without changing respective differences of the switching duty cycles of the switching cells in the submodules of the power converter. In other examples, the switching duty cycles are adjusted such that other relationships between the switching duty cycles are maintained, for example to control other suitable parameters of the power converter and/or to provide decoupling between control of the power converter for other suitable control objectives.

At block 808, the controller may provide the plurality of the control signals to the plurality of switching cells to control the switching duty cycles of the plurality of switching cells.

In various embodiments, benefits of the disclosed systems and methods include achieving control objectives in a decoupled way: output current is regulated, input voltages are kept balanced, and circulating currents are regulated to 0, with same dynamics as output current control. The disclosed control systems and methods may thus guarantee optimal operation of the power converter, in terms of current ripples, semiconductor voltage stresses, and magnetic core utilization, consequently increasing overall system efficiency and cost. The manipulation of the switching duty cycles d₁, d₂, d₃, d₄ to maintain certain sums and differences between the switching duty cycles d₁, d₂, d₃, d₄ enables decoupled control of the control objectives, such as decoupled regulation of output current, elimination of circulating currents in submodules of the power converter and balancing of input voltages provided to the submodules of the power converter. In some embodiments, additional decoupling between voltage balancer and output current regulation is provided in two ways: bandwidth separation (balancer is designed to be much slower), and feedforward action from balancer to output current controller. Oversampled averaging provides that feedback values correspond to their true average values is utilized in some embodiments, thus minimizing, or preventing, regulation errors.

In an embodiment, a power converter system includes a power converter including a plurality of switching cells arranged in a plurality of submodules, and a controller configured to: obtain a plurality of feedback signals indicative a plurality of controlled parameters of the power converter; detect, based on the plurality of feedback signals, changes in respective ones of the plurality of controlled parameters during operation of the power converter; generate, based on the changes in respective ones of the plurality of controlled parameters, a plurality of control signals for adjusting respective duty cycles of the plurality of switching cells to control the power converter for a plurality of control objectives, wherein the controller is configured to adjust the duty cycles such that one or more relationships between the respective duty cycles are maintained to provide that controlling the power converter for one of the plurality of control objectives does not affect control of the power converter for another one of the plurality of control objectives; and provide the plurality of the control signals to the plurality of switching cells to control the duty cycles of the plurality of switching cells.

In other embodiments, the power converter system further includes any suitable combination of one or more of the following features.

The plurality of controlled parameters includes i) a regulated output of the power converter, and one or both of i) one or more circulating currents in the plurality of submodules of the power converter and iii) respective input voltages provided to respective ones of the plurality of submodules of the power converter.

The regulated output of the power converter includes one or more of i) a regulated output current of the power converter, ii) a regulated output voltage of the power converter, or iii) a regulated output power of the power converter.

The plurality of control objectives includes i) regulation of the output current of the power converter and one or both of ii) cancellation of the one or more circulating currents in the power converter and iii) elimination of a disbalance between the respective input voltages provided to respective ones of the plurality of submodules of the power converter.

The plurality of submodules includes at least a first submodule placed in series with a second submodule, wherein i) the first submodule includes a first switching cell placed in parallel with a second switching cell and ii) the second submodule includes a third switching cell placed in parallel with a fourth switching cell.

The power converter further includes i) a first coupled inductor coupled to respective output terminals of the first switching cell and the second switching cell of the first submodule to generate a combined output of the first submodule and ii) a second coupled inductor coupled to respective output terminals of the third switching cell and the fourth switching cell of the second submodule to generate a combined output of the second submodule.

The controller is configured to: control the power converter for elimination of circulating currents in the first coupled inductor by changing a difference between a first duty cycle of the first switching cell and a second duty cycle of the second switching cell such that a sum between the first duty cycle of the first switching cell and the second duty cycle of the second switching cell remains unchanged, and control the power converter for elimination of circulating currents in the second coupled inductor by changing a difference between a third duty cycle of the third switching cell and a fourth duty cycle of the fourth switching cell such that a sum between the third duty cycle of the third switching cell and the fourth duty cycle of the fourth switching cell remains unchanged.

The controller is further configured to control the power converter for elimination of disbalance between input voltages suppled to the first submodule and the second submodule by changing a difference between i) a mean value of the first duty cycle and the second duty cycle and ii) a mean value of the third duty cycle and the fourth duty cycle such that i) the difference between the first duty cycle and the second duty cycle remains unchanged so as to not affect the circulating current in the first coupled inductor and ii) the difference between the third duty cycle and the fourth duty cycle remains unchanged.

The controller is further configured to implement a feedforward correction to compensate for an effect that control of the power converter for elimination of disbalance between input voltages suppled to the first submodule and the second submodule has on regulation of an output current of the power converter.

The controller includes an oversampling engine configured to generate oversampled averaged values of the feedback signals, and wherein the controller is configured to generate the control signals based on the oversampled averaged values of the feedback signals.

In another embodiment, a method for controlling operating of a power converter includes: obtaining, by a controller, a plurality of feedback signals indicative of a plurality of controlled parameters of the power converter, wherein the power converter includes a plurality of switching cells arranged in a plurality of submodules; detecting, by the controller based on the plurality of feedback signals, changes in respective ones of the plurality of controlled parameters during operation of the power converter; generating, by the controller based on the changes in respective ones of the plurality of controlled parameters, a plurality of control signals for adjusting respective duty cycles of the plurality of switching cells to control the power converter for a plurality of control objectives, wherein the duty cycles are adjusted such that one or more relationships between the respective duty cycles are maintained to provide that controlling the power converter for one of the plurality of control objectives does not affect control of the power converter for another one of the plurality of control objectives; and providing, by the controller, the plurality of the control signals to the plurality of switching cells to control the duty cycles of the plurality of switching cells.

In other embodiments, the method further includes any suitable combination of one or more of the following features.

The plurality of controlled parameters includes i) a regulated output of the power converter, and one or both of i) one or more circulating currents in the plurality of submodules of the power converter and iii) respective input voltages provided to respective ones of the plurality of submodules of the power converter.

The regulated output of the power converter includes one or more of i) a regulated output current of the power converter, ii) a regulated output voltage of the power converter, or iii) a regulated output power of the power converter.

The plurality of control objectives includes i) regulation of the output current of the power converter and one or both of ii) cancellation of the one or more circulating currents in the power converter and iii) elimination of a disbalance between the respective input voltages provided to respective ones of the plurality of submodules of the power converter.

The plurality of submodules includes at least a first submodule placed in series with a second submodule, wherein i) the first submodule includes a first switching cell placed in parallel with a second switching cell and ii) the second submodule includes a third switching cell placed in parallel with a fourth switching cell.

The power converter further includes i) a first coupled inductor coupled to respective output terminals of the first switching cell and the second switching cell of the first submodule to generate a combined output of the first submodule and ii) a second coupled inductor coupled to respective output terminals of the third switching cell and the fourth switching cell of the second submodule to generate a combined output of the second submodule.

Adjusting the plurality of duty cycles to control the power converter for elimination of circulating currents in the first coupled inductor includes changing a difference between a first duty cycle of the first switching cell and a second duty cycle of the second switching cell such that a sum between the first duty cycle of the first switching cell and the second duty cycle of the second switching cell remains unchanged.

Adjusting the plurality of duty cycles to control the power converter for elimination of circulating currents in the second coupled inductor by changing a difference between a third duty cycle of the third switching cell and a fourth duty cycle of the fourth switching cell such that a sum between the third duty cycle of the third switching cell and the fourth duty cycle of the fourth switching cell remains unchanged.

The method further includes adjusting the plurality of duty cycles to control the power converter for elimination of disbalance between input voltages suppled to the first submodule and the second submodule by changing a difference between i) a mean value of the first duty cycle and the second duty cycle and ii) a mean value of the third duty cycle and the fourth duty cycle such that i) the difference between the first duty cycle and the second duty cycle remains unchanged so as to not affect the circulating current in the first coupled inductor and ii) the difference between the third duty cycle and the fourth duty cycle remains unchanged.

The method further includes generating, by the controller, oversampled averaged values of the feedback signals, wherein generating the plurality of control signals includes generating the plurality of control signals based on the oversampled averaged values of the feedback signals.

In still another embodiment, a controller for a power converter includes: a feedback signal engine configured to obtain a plurality of feedback signals indicative of a plurality of controlled parameters in the power converter, wherein the power converter includes a plurality of switching cells arranged in a plurality of submodules; and a plurality of control loops configured to generate, based on the changes in respective ones of the plurality of controlled parameters, a plurality of control signals for adjusting respective duty cycles of the plurality of switching cells to control the power converter for a plurality of control objectives, wherein the controller is configured to adjust the duty cycles such that one or more relationships between the respective duty cycles are maintained to provide that controlling the power converter for one of the plurality of control objectives does not affect control of the power converter for another one of the plurality of control objectives.

In other embodiments, the controller further includes any suitable combination of one or more of the following features.

The plurality of controlled parameters includes i) a regulated output of the power converter, and one or both of i) one or more circulating currents in the plurality of submodules of the power converter and iii) respective input voltages provided to respective ones of the plurality of submodules of the power converter.

The regulated output of the power converter includes one or more of i) a regulated output current of the power converter, ii) a regulated output voltage of the power converter, or iii) a regulated output power of the power converter.

The plurality of control objectives includes i) regulation of the output current of the power converter and one or both of ii) cancellation of the one or more circulating currents in the power converter and iii) elimination of a disbalance between the respective input voltages provided to respective ones of the plurality of submodules of the power converter.

The plurality of submodules includes at least a first submodule placed in series with a second submodule, wherein i) the first submodule includes a first switching cell placed in parallel with a second switching cell and ii) the second submodule includes a third switching cell placed in parallel with a fourth switching cell.

The power converter further includes i) a first coupled inductor coupled to respective output terminals of the first switching cell and the second switching cell of the first submodule to generate a combined output of the first submodule and ii) a second coupled inductor coupled to respective output terminals of the third switching cell and the fourth switching cell of the second submodule to generate a combined output of the second submodule.

The plurality of control loops are configured to: generate the plurality of control signals to control the power converter for elimination of circulating currents in the first coupled inductor by changing a difference between a first duty cycle of the first switching cell and a second duty cycle of the second switching cell such that a sum between the first duty cycle of the first switching cell and the second duty cycle of the second switching cell remains unchanged, and generate the plurality of control signals to control the power converter for elimination of circulating currents in the second coupled inductor by changing a difference between a third duty cycle of the third switching cell and a fourth duty cycle of the fourth switching cell such that a sum between the third duty cycle of the third switching cell and the fourth duty cycle of the fourth switching cell remains unchanged.

The plurality of control loops are further configured to generate the plurality of control signal to control the power converter for elimination of disbalance between input voltages suppled to the first submodule and the second submodule by changing a difference between i) a mean value of the first duty cycle and the second duty cycle and ii) a mean value of the third duty cycle and the fourth duty cycle such that i) the difference between the first duty cycle and the second duty cycle remains unchanged so as to not affect the circulating current in the first coupled inductor and ii) the difference between the third duty cycle and the fourth duty cycle remains unchanged.

The feedback signal engine is configured to configured to generate oversampled averaged values of the feedback signals, and wherein the plurality of control loops are configured to generate at least dome of the control signals based on the oversampled averaged values of the feedback signals.

Portions of the methods, devices, and systems, such as processing, and logic described above, may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be embodied as a signal and/or data stream and/or may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may particularly include a storage medium and instructions stored in or on the medium, and the instructions when executed by the circuitry in a device may cause the device to implement any of the processing described above or illustrated in the drawings.

The implementations may be distributed as circuitry, e.g., hardware, and/or a combination of hardware and software among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry. Various example implementations have been included for illustration. Other implementations are possible.

One or more implementations of the disclosure may be referred to herein, individually and/or collectively, by the term “invention” merely for convenience and without intending to voluntarily limit the scope of this application to any particular invention or inventive concept. Moreover, although specific implementations have been illustrated and described herein, it should be appreciated that any subsequent arrangement designed to achieve the same or similar purpose may be substituted for the specific implementations shown. This disclosure is intended to cover any and all subsequent adaptations or variations of various implementations. Combinations of the above implementations, and other implementations not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding implementations illustrated in the present disclosure and are not meant to be limiting in any fashion. Nor do these phrases indicate any kind of preference for the disclosed implementations.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single implementation for the purpose of streamlining the disclosure. This disclosure is not to be interpreted as reflecting an intention that the claimed implementations require more features than are expressly recited in each claim. Rather, as the following claims reflect, inventive subject matter may be directed to less than all of the features of any of the disclosed implementations. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are within the scope of the disclosure. The claims should not be read as limited to the described order or elements unless stated to that effect. Therefore, all implementations that come within the scope and spirit of the following claims and equivalents thereto are included within the disclosure.

1. A power converter system comprising:
a power converter including a plurality of switching cells arranged in a plurality of submodules; and
a controller configured to:
obtain a plurality of feedback signals indicative a plurality of controlled parameters of the power converter;
detect, based on the plurality of feedback signals, changes in respective ones of the plurality of controlled parameters during operation of the power converter;
generate, based on the changes in respective ones of the plurality of controlled parameters, a plurality of control signals for adjusting duty cycles of the plurality of switching cells to control the power converter for a plurality of control objectives, wherein the controller is configured to adjust the duty cycles such that one or more relationships between the respective duty cycles are maintained to provide that controlling the power converter for one of the plurality of control objectives does not affect control of the power converter for another one of the plurality of control objectives; and
provide the plurality of the control signals to the plurality of switching cells to control the duty cycles of the plurality of switching cells,
wherein i) the first submodule of the plurality of submodules includes a first switching cell placed in parallel with a second switching cell and ii) the second submodule of the plurality of submodules includes a third switching cell placed in parallel with a fourth switching cell.

2. The power converter of claim 1, wherein the plurality of controlled parameters includes i) a regulated output of the power converter, and one or both of i) one or more circulating currents in the plurality of submodules of the power converter and iii) respective input voltages provided to respective ones of the plurality of submodules of the power converter.

3. The power converter of claim 2, wherein the regulated output of the power converter comprises one or more of i) a regulated output current of the power converter, ii) a regulated output voltage of the power converter, or iii) a regulated output power of the power converter.

4. The power converter of claim 2, wherein the plurality of control objectives includes i) regulation of the output the power converter and one or both of ii) cancellation of the one or more circulating currents in the power converter and iii) elimination of a disbalance between the respective input voltages provided to respective ones of the plurality of submodules of the power converter.

5. The power converter system of claim 1, wherein the plurality of submodules includes at least a first submodule placed in series with a second submodule, and
wherein the power converter further comprises i) a first coupled inductor coupled to respective output terminals of the first switching cell and the second switching cell of the first submodule to generate a combined output of the first submodule and ii) a second coupled inductor coupled to respective output terminals of the third switching cell and the fourth switching cell of the second submodule to generate a combined output of the second submodule.

6. The power converter system of claim 5, wherein the controller is further configured to:
control the power converter for elimination of circulating currents in the first coupled inductor by changing a difference between a first duty cycle of the first switching cell and a second duty cycle of the second switching cell such that a sum between the first duty cycle of the first switching cell and the second duty cycle of the second switching cell remains unchanged, and
control the power converter for elimination of circulating currents in the second coupled inductor by changing a difference between a third duty cycle of the third switching cell and a fourth duty cycle of the fourth switching cell such that a sum between the third duty cycle of the third switching cell and the fourth duty cycle of the fourth switching cell remains unchanged.

7. The power converter system of claim 6, wherein the controller is further configured to control the power converter for elimination of disbalance between input voltages suppled to the first submodule and the second submodule by changing a difference between i) a mean value of the first duty cycle and the second duty cycle and ii) a mean value of the third duty cycle and the fourth duty cycle such that i) the difference between the first duty cycle and the second duty cycle remains unchanged so as to not affect the circulating current in the first coupled inductor and ii) the difference between the third duty cycle and the fourth duty cycle remains unchanged.

8. The power converter system of claim 7, wherein the controller is further configured to implement a feedforward correction to compensate for an effect that control of the power converter for elimination of disbalance between input voltages suppled to the first submodule and the second submodule has on regulation of an output current of the power converter.

9. The power converter system of claim 1, wherein the controller includes an oversampling engine configured to generate oversampled averaged values of the feedback signals, and
wherein the controller is further configured to generate at least some of the control signals based on the oversampled averaged values of the feedback signals.

10. A method for controlling operating of a power converter, the method comprising:
obtaining, by a controller, a plurality of feedback signals indicative of a plurality of controlled parameters of the power converter, wherein the power converter includes a plurality of switching cells arranged in a plurality of submodules;
detecting, by the controller based on the plurality of feedback signals, changes in respective ones of the plurality of controlled parameters during operation of the power converter;
generating, by the controller based on the changes in respective ones of the plurality of controlled parameters, a plurality of control signals for adjusting duty cycles of the plurality of switching cells to control the power converter for a plurality of control objectives, wherein the duty cycles are adjusted such that one or more relationships between the respective duty cycles are maintained to provide that controlling the power converter for one of the plurality of control objectives does not affect control of the power converter for another one of the plurality of control objectives; and
providing, by the controller, the plurality of the control signals to the plurality of switching cells to control the duty cycles of the plurality of switching cells,
wherein i) the first submodule of the plurality of submodules includes a first switching cell placed in parallel with a second switching cell and ii) the second submodule of the plurality of submodules includes a third switching cell placed in parallel with a fourth switching cell.

11. The method of claim 10, wherein the plurality of controlled parameters includes i) a regulated output of the power converter, and one or both of ii) one or more circulating currents in the plurality of submodules of the power converter and iii) respective input voltages provided to respective ones of the plurality of submodules of the power converter.

12. The method of claim 11, wherein the regulated output of the power converter comprises one or more of i) a regulated output current of the power converter, ii) a regulated output voltage of the power converter, or iii) a regulated output power of the power converter.

13. The method of claim 11, wherein the plurality of control objectives includes i) regulation of the output current of the power converter and one or both of ii) cancellation of the one or more circulating currents in the power converter and iii) elimination of a disbalance between the respective input voltages provided to respective ones of the plurality of submodules of the power converter.

14. The method of claim 10, wherein the plurality of submodules includes at least a first submodule placed in series with a second submodule,
wherein the power converter further comprises i) a first coupled inductor coupled to respective output terminals of the first switching cell and the second switching cell of the first submodule to generate a combined output of the first submodule and ii) a second coupled inductor coupled to respective output terminals of the third switching cell and the fourth switching cell of the second submodule to generate a combined output of the second submodule, and
wherein the method further comprises:
adjusting the plurality of duty cycles to control the power converter for elimination of circulating currents in the first coupled inductor comprises changing a difference between a first duty cycle of the first switching cell and a second duty cycle of the second switching cell such that a sum between the first duty cycle of the first switching cell and the second duty cycle of the second switching cell remains unchanged; and
adjusting the plurality of duty cycles to control the power converter for elimination of circulating currents in the second coupled inductor by changing a difference between a third duty cycle of the third switching cell and a fourth duty cycle of the fourth switching cell such that a sum between the third duty cycle of the third switching cell and the fourth duty cycle of the fourth switching cell remains unchanged.

15. The method of claim 14, further comprising:
adjusting the plurality of duty cycles to control the power converter for elimination of disbalance between input voltages suppled to the first submodule and the second submodule by changing a difference between i) a mean value of the first duty cycle and the second duty cycle and ii) a mean value of the third duty cycle and the fourth duty cycle such that i) the difference between the first duty cycle and the second duty cycle remains unchanged so as to not affect the circulating current in the first coupled inductor and ii) the difference between the third duty cycle and the fourth duty cycle remains unchanged.

16. The method of claim 15, further comprising:
generating, by the controller, oversampled averaged values of the feedback signals, wherein generating the plurality of control signals comprises generating the plurality of control signals based on the oversampled averaged values of the feedback signals.

17. A controller for a power converter, the controller comprising:
a feedback signal engine configured to obtain a plurality of feedback signals indicative of a plurality of controlled parameters of the power converter, wherein the power converter includes a plurality of switching cells arranged in a plurality of submodules; and
a plurality of control loops configured to generate, based on detected changes in respective ones of the plurality of controlled parameters, a plurality of control signals for adjusting respective duty cycles of the plurality of switching cells to control the power converter for a plurality of control objectives, wherein the controller is configured to adjust the duty cycles such that one or more relationships between the respective duty cycles are maintained to provide that controlling the power converter for one of the plurality of control objectives does not affect control of the power converter for another one of the plurality of control objectives,
wherein i) the first submodule of the plurality of submodules includes a first switching cell placed in parallel with a second switching cell and ii) the second submodule of the plurality of submodules includes a third switching cell placed in parallel with a fourth switching cell.

18. The controller of claim 17, wherein the plurality of controlled parameters includes i) a regulated output of the power converter, and one or both of i) one or more circulating currents in the plurality of submodules of the power converter and iii) respective input voltages provided to respective ones of the plurality of submodules of the power converter.

19. The controller of claim 18, wherein the regulated output of the power converter comprises one or more of i) a regulated output current of the power converter, ii) a regulated output voltage of the power converter, or iii) a regulated output power of the power converter.

20. The controller of claim 18, wherein the plurality of control objectives includes i) regulation of the output current of the power converter and one or both of ii) cancellation of the one or more circulating currents in the power converter and iii) elimination of a disbalance between the respective input voltages provided to respective ones of the plurality of submodules of the power converter.

21. (canceled)

22. (canceled)

23. (canceled)
